(19) United States
(12) Patent Application Publication
(10) Pub. No.: US 2005/0289278 A1
(43) Pub. Date: Dec. 29, 2005

(54) Apparatus and method for programmable completion tracking logic to support multiple virtual channels

(76) Inventors: Thian Aun Tan, Bayan Lepas (MY); Vui Yong Liew, Sungai Ara (MY); Mikal C. Hunsaker, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/877,560

(22) Filed: Jun. 24, 2004

(51) Int. Cl. G06F 13/00

(52) U.S. Cl. 710/310

(57) ABSTRACT

Method and apparatus for programmable completion tracking logic to support multiple virtual channels. In one embodiment, the apparatus includes a controller having the programmable completion tracking logic for supporting multiple virtual channels. In one embodiment, a completion tracking queue is programmable to provide a predetermined number of entries to store upstream non-posted (NP) read request information corresponding to a virtual channel from a plurality of virtual channels supported by the controller. In one embodiment, the predetermined number of entries are shared among the plurality of virtual channels according to a minimum entry value and a maximum entry value defined for each respective virtual channel. Other embodiments are described and claimed.

### FIELD OF THE INVENTION

One or more embodiments of the invention relate generally to the field of integrated circuit and computer system design. More particularly, one or more of the embodiments of the invention relate to a method and apparatus for programmable completion tracking logic to support multiple virtual channels.

### BACKGROUND OF THE INVENTION

Communication between devices within a computer system is typically performed using one or more busses to interconnect the devices. These busses may be dedicated busses coupling two devices or non-dedicated multi-drop busses that are multiplexed by a number of units and devices (e.g., bus agents). In addition, these busses may be dedicated to transferring a specific type of information. For example, many microprocessor architectures include a three-bus system comprised of address, data and control busses for respectively transferring data, address and control signals.

A vast amount of research in architecture design is directed to increasing data throughput within computer systems. One area of focus is directed towards increasing the processing speed and bandwidth available to peripheral devices. During the past decade, peripheral component interconnect (PCI) has provided a very successful general purpose input/output (I/O) interconnection standard. PCI is a general purpose I/O interconnect standard that utilizes PCI signaling technology, including a multi-drop parallel bus implementation. Unfortunately, the decade of time since the introduction of PCI has resulted in the identification of the various shortcomings of PCI.

PCI operates according to a reflected wave signaling technique, where a half signal swing signal is propagated, such that once reflected, the signal achieves a full signal swing. However, as electrical loads on a PCI bus are increased, the set-up time required to achieve the full signal swing fails to meet timing requirements. Furthermore, the low clock speed, the use of delayed transactions and wait states, as well as other deficiencies, resulted in poor performance for PCI devices. As a result, system architects have devised PCI-X to target deficiencies in the PCI bus protocol.

Unfortunately, PCI-X retains many of the deficiencies attributed to the PCI bus protocol. For example, PCI-X retains the reflected wave signaling technique of PCI. Due to the use of the reflected wave signaling, it is a challenge to design a device or system that satisfies PCI-X signal timing requirements as additional device loads are added to a PCI-X bus. As a result, the number of loads on a PCI-X bus to one device is effectively reduced to meet PCI-X signal timing requirements. As a result, PCI Express (PCI_XP) is designed to overcome deficiencies of PCI and PCI-X.

A PCI-XP link provides a point-to-point link, as defined by PCI Express Base Specification 1.0a (Errata dated 7 Oct. 2003) to allow bi-directional communication between peripheral endpoint devices via a switch. Accordingly, the various peripheral endpoints coupled to a PCI-XP link are required to arbitrate for ownership of PCI-XP link to issue transactions. Such arbitration is required since endpoints are generally not allowed to simultaneously drive a PCI-XP link. PCI-XP encodes transactions using a packet-based protocol. Packets are transmitted and received serially and byte stripped across the available lanes of a PCI-XP link.

PCI-XP transactions can be divided into two categories. Those transactions that are non-posted and those that are posted. Non-posted transactions, such as memory reads, implement a split transaction communication model similar to the legacy PCI-X split transaction protocol. For example, a requester device transmits a non-posted type memory read request packet to a completer. The completer returns a completion packet with the read data to the requester. Posted transactions, such as memory writes, consist of a completer with no completion packet returned from completer to requester. Unexpected completions, as well as completion time-out, are two new error handling scenarios defined by PCI-XP.

### BRIEF DESCRIPTION OF THE DRAWINGS

The various embodiments of the present invention are illustrated by way of example, and not by way of limitation, in the figures of the accompanying drawings and in which:

FIG. 1 is a block diagram illustrating a computer system including completion tracking logic to support multiple virtual channels, in accordance with one embodiment.

FIG. 2 is a block diagram illustrating one or more virtual channels supported by the computer system, as illustrated in FIG. 1, in accordance with one embodiment.

FIG. 3 is a block diagram further illustrating the input/output (I/O) controller hub (ICH) backbone of FIG. 1, in accordance with one embodiment.

FIG. 4 is a block diagram further illustrating the completion tracking logic of FIG. 1, in accordance with one embodiment.

FIG. 5 is a block diagram further illustrating the completion tracking queue of FIG. 4, in accordance with one embodiment.

FIGS. 6A-6C illustrate programming of minimum and maximum entry values defined for the completion tracking queue of FIG. 4, in accordance with one embodiment.

FIG. 7 is a flowchart illustrating a method for completion tracking of upstream requests, in accordance with one embodiment.

FIG. 8 is a flowchart illustrating a method for allocating entries within a completion tracking pool, in accordance with one embodiment.

FIG. 9 is a flowchart illustrating a method for transmitting an upstream request according to available entries within a completion tracking queue for virtual channel, in accordance with one embodiment.

FIG. 10 is a flowchart for allocating entries to virtual channels within the completion tracking queue, in accordance with one embodiment.

FIG. 11 is a flowchart illustrating a method for discarding unmatched, received completions, in accordance with one embodiment.

FIG. 12 is a flowchart illustrating a method for synthesizing completions with error completion status, in accordance with one embodiment.

FIG. 13 is a flowchart illustrating a method for removing upstream request information from a completion tracking queue, in accordance with one embodiment.

FIG. 14 is a block diagram illustrating various design representations or formats for simulation, emulation and fabrication of a design using the disclosed techniques.

### DETAILED DESCRIPTION

A method and apparatus for programmable completion tracking logic to support multiple virtual channels are described. In one embodiment, the apparatus includes a controller having programmable completion tracking logic for supporting multiple virtual channels. In one embodiment, a completion tracking queue is programmable to provide a predetermined number of entries to store upstream read request information corresponding to a virtual channel from a plurality of virtual channels supported by the controller. In one embodiment, the predetermined number of entries are shared among the plurality of virtual channels according to a minimum entry value and a maximum entry value defined for each respective virtual channel.

In one embodiment, control logic prohibits transmission of an upstream read request for a virtual channel unless an entry within the completion tracking queue is available for the virtual channel. Accordingly, in one embodiment, a common pool of entries within the completion tracking queue are made available to the multiple virtual channels provided by the controller to provide a varying quality of service (QoS) to a plurality of traffic classes defined for the controller.

In the following description, numerous specific details such as logic implementations, sizes and names of signals and buses, types and interrelationships of system components, and logic partitioning/integration choices are set forth to provide a more thorough understanding. It will be appreciated, however, by one skilled in the art that the invention may be practiced without such specific details. In other instances, control structures and gate level circuits have not been shown in detail to avoid obscuring the invention. Those of ordinary skill in the art, with the included descriptions, will be able to implement appropriate logic circuits without undue experimentation.

In the following description, certain terminology is used to describe features of the invention. For example, the term “logic” is representative of hardware and/or software configured to perform one or more functions. For instance, examples of “hardware” include, but are not limited or restricted to, an integrated circuit, a finite state machine or even combinatorial logical. The integrated circuit may take the form of a processor such as a microprocessor, application specific integrated circuit, a digital signal processor, a micro-controller, or the like.

System

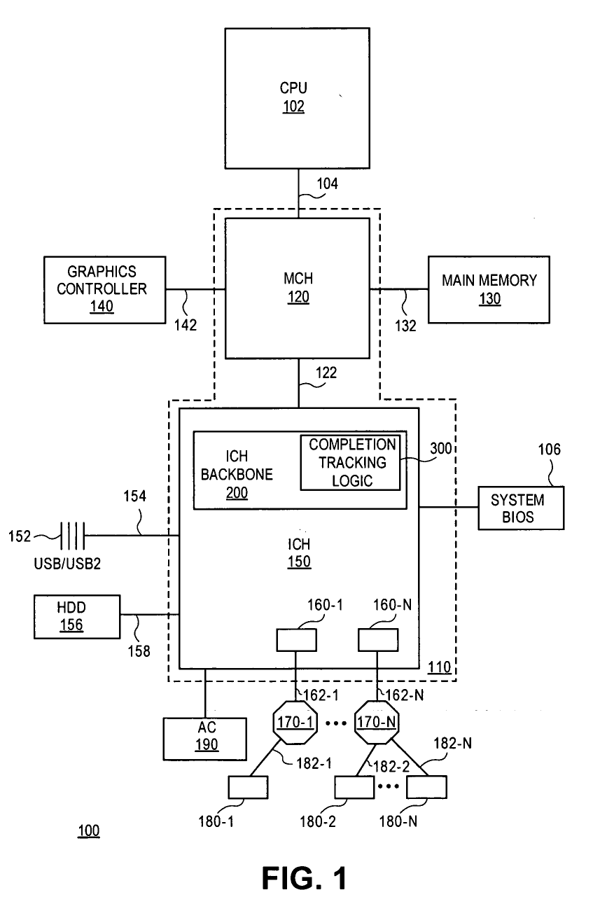

FIG. 1 is a block diagram illustrating computer system 100 including completion tracking logic 300 to support multiple virtual channels, in accordance with one embodiment. Representatively, computer system 100 comprises a processor system bus (front side bus (FSB)) 104 for communicating information between processor (CPU) 102 and chipset 110. As described herein, the term “chipset” is used in a manner to collectively describe the various devices coupled to CPU 102 to perform desired system functionality.

Representatively, chipset 110 may include memory controller hub 120 (MCH) coupled to graphics controller 140. In an alternative embodiment, graphics controller 140 is integrated into MCH, such that, in one embodiment, MCH 200 operates as an integrated graphics MCH (GMCH). Representatively, MCH 200 is also coupled to main memory 130. In one embodiment, main memory 130 may include, but is not limited to, random access memory (RAM), dynamic RAM (DRAM), static RAM (SRAM), synchronous DRAM (SDRAM), double data rate (DDR) SDRAM (DDR-SDRAM), Rambus DRAM (RDRAM) or any device capable of supporting high-speed buffering of data.

As further illustrated, chipset 110 includes an input/output (I/O) controller hub (ICH) 150. Representatively, ICH 150 may include a universal serial bus (USB) link or interconnect 154 to couple one or more USB slots 152 to ICH 150. In addition, an audio codec (AC) 190 may be coupled to ICH 150. Likewise, a serial advance technology attachment (SATA) 158 may couple hard disk drive devices (HDD) 156 to ICH 150. Likewise, ICH 150 may include peripheral component interconnect (PCI) PCI-Express (PCI-XP) root ports 160 (160-1, . . . 160-N) to couple switches 170 (170-1, . . . , 170-N) to ICH 150 via PCI-XP links 162 (162-1, . . . , 162-N) referred to herein as the “fabric”. In one embodiment, system BIOS 106 initializes computer system 100.

Although chipset 110 is illustrated as including a separate MCH 120 and ICH 150, in one embodiment, MCH 120 may be integrated within CPU 102. In an alternate embodiment, the functionality of MCH 120 and ICH 150 are integrated within chipset 110. In one embodiment, completion tracking logic 300 may be implemented within computer systems including an MCH integrated within a CPU, an MCH and ICH integrated within a chipset, as well as a system on-chip. Accordingly, those skilled in the art recognize that FIG. 1 is provided to illustrate one embodiment and should not be construed in a limiting manner.

Representatively, PCI-XP links 162 may provide a point-to-point link, such as defined by PCI Express Base Specification 1.0a (Errata dated 7 Oct. 2003) to allow bi-directional communication between peripheral endpoint devices 180 (180-1, . . . , 180-N) via switch 170. Accordingly, the various peripheral endpoints 180 are required to arbitrate for ownership of PCI-XP link 162 to issue transactions. Such arbitration is required since endpoints 180 are generally not allowed to simultaneously drive PCI-XP link 162. As described herein, an endpoint that is requesting data is referred to as a “requester”. Likewise, an endpoint from which data is requested is referred to as a “completer”.

PCI-XP encodes transactions using a packet-based protocol. Packets are transmitted and received serially and byte stripped across the available lanes of a PCI-XP link. In one embodiment, ICH backbone 200 of ICH 150 provides varying quality of service (QoS) for various traffic classes defined according to the packet-based communication provided by PCI-XP, which are routed via virtual channels (VCs). The QoS feature of PCI-XP refers to the capability of routing packets from different applications through the fabric with differentiated priorities and deterministic latencies and bandwidth.

Providing varying QoS to PCI-XP packets involves the definition of at least two traffic classes (TC). Once defined, packets associated with an application a TC are assigned the respective TC within a packet header. PCI-XP packets contain a TC number between 0 and 7 that is assigned by the device application or device driver. Packets with different TCs can move through the fabric with different priority, resulting in varying performance. These packets arrive through the fabric by utilizing virtual channel (VC) buffers implemented in switches, endpoints and root complex devices, such as ICH 150.

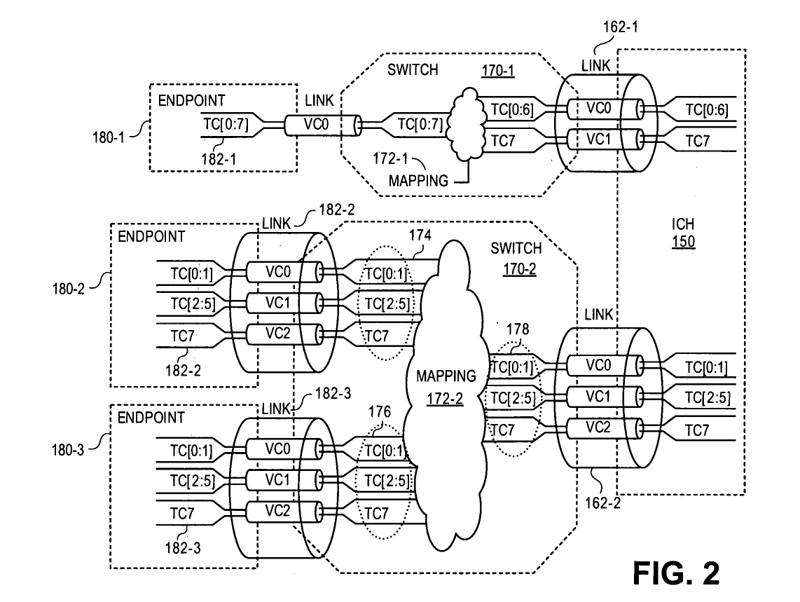

In one embodiment, as illustrated in FIG. 2, ICH 150 provides three virtual channels: (1) virtual channel zero (VC0) to provide best effort QoS; (2) virtual channel one (VC1) to provide guaranteed latencies, such as required by isochronous traffic; and (3) virtual channel two (VC2) that is used to service snoop isochronous traffic, such as USB/USB2 devices 152, AC devices 190 or the like. Accordingly, as illustrated with reference to FIG. 2, traffic classes TC0 and TC1 are associated with virtual channel VC0, while traffic classes TC2-TC5 are associated with virtual channel VC1 and traffic class TC7 is associated with virtual channel VC2.

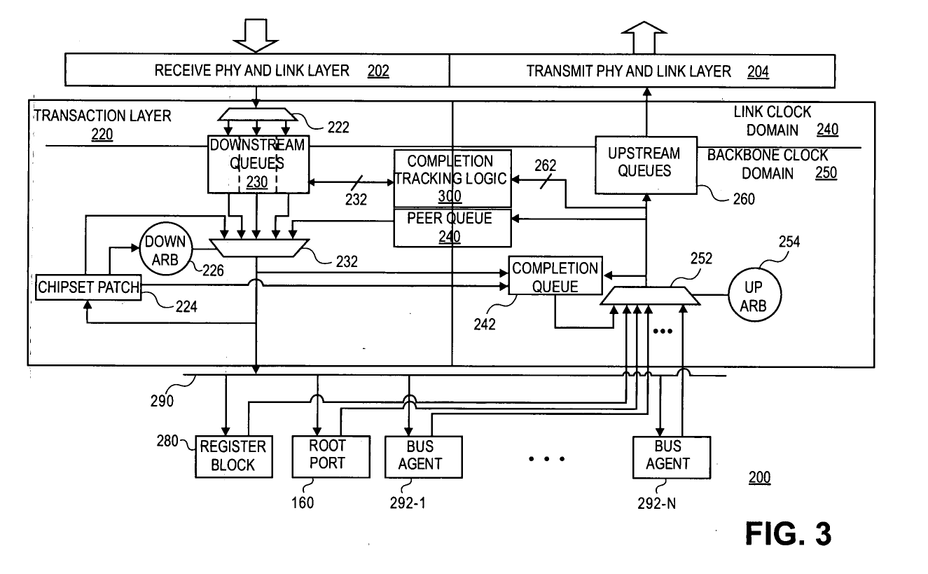

FIG. 3 further illustrates ICH backbone 200 of FIG. 1, in accordance with one embodiment. As illustrated in FIG. 3, the PCI-XP architecture is specified in layers. At so-called “higher layers”, communication between peers in two devices (also referred to as a requester and a completer) may be conducted using transactions. For example, there are memory transactions that transfer data to or from a memory mapped location.

There may be three layers that build a transaction. The first layer may be the transaction layer, which begins the process of turning a request or completion data coming from a device core into packet data for a transaction. The second architectural build layer is called the data link layer; it ensures the packets going back and forth across the link are properly received (via techniques, such as error control coding). The third layer is called the physical layer. This layer is responsible for the actual transmitting and receiving of the packet across the link.

Furthermore, PCI-XP transactions can be divided into two categories. Those transactions that are non-posted and those that are posted. Non-posted transactions, such as memory reads, implement a split transaction communication model similar to the legacy PCI (PCI-X) split transaction protocol. For example, a requester device transmits a non-posted type memory read request packet to a completer. The completer returns a completion packet with the read data to the requester. Posted transactions, such as memory writes, consist of a completer with no completion packet returned from completer to requester.

Referring again to FIG. 3, transaction layer 220 of ICH backbone is further illustrated. In one embodiment, when a PCI-XP upstream read request is transmitted, information about the read request needs to be stored and associated with a returning downstream completion. As described herein, “upstream read request” or “upstream request” refers to requests going from endpoints 180 via ICH 150 and MCH 110 to main memory 130. Conversely, “downstream completions” refer to completions traversing from, for example, main memory 130 through MCH 110 and ICH 150 for final delivery to endpoint 180 (see FIG. 1).

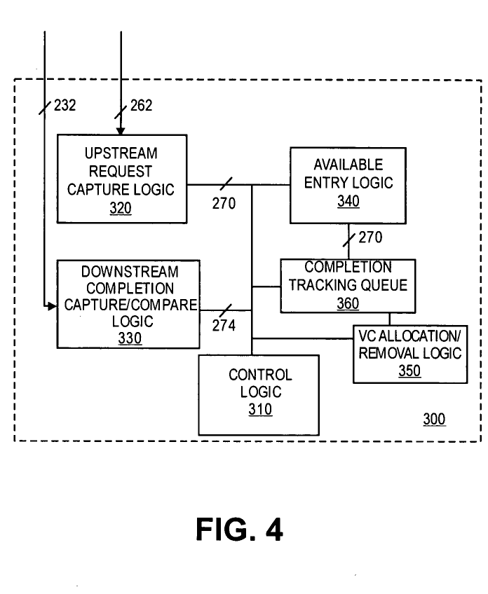

Referring again to FIG. 3, in one embodiment, request information associated with an upstream non-posted (NP) read request is stored within completion tracking logic 300, which may include completion tracking queue 360, as shown in FIG. 4. In one embodiment, completion tracking logic 300 sits “sideways” between upstream queue 260 and downstream queue 230. In one embodiment, completion tracking logic 300 stores upstream NP read request information targeting main memory 130.

In one embodiment, completion tracking logic supports error handling of unexpected completions, as well as completion time-out, which are two new error handling scenarios defined by the PCI-XP. For example, when a completion is returned from memory 130, completion tracking logic 300 compares the completion information with request information within completion tracking queue 360 (FIG. 4). If a match is not detected, the completion is assumed to be unexpected and is discarded, resulting in the logging of an error by completion tracking logic 300. Such discarded completions are referred to herein as “unexpected completions”.

In one embodiment, if a completion for an upstream NP request is not returned within a predetermined period of time, such as, for example, 20 milliseconds (ms), the transaction is considered to have timed out and an error is logged. In one embodiment, completion tracking logic 300 synthesizes a completion with error completion status. In one embodiment, the synthesized completion is provided to prevent legacy devices from exhibiting undesired or unintended behavior, which may hang computer system 100. In one embodiment, request information logic 310, as shown in FIG. 4, performs the above-described error support handling for unexpected completions, as well as completion time-out.

In one embodiment, as illustrated in FIG. 4, before upstream NP request 262 can be transmitted, there must be room in completion tracking queue 360 to store request information 270 associated with the upstream NP read request 262. In one embodiment, available entry logic 340 determines whether an entry within completion track queue 360 is available for the VC associated with upstream NP read request 262. However, because of the support of multiple virtual channels, in one embodiment, entries are allocated for each VC to limit the number of outstanding requests for that VC, such that read requests from one particular VC do not starve requests from the other VCs.

In addition, bandwidth requirements of read requests on the different VCs may vary quite significantly from one platform to another (e.g., between a desktop and a server), thus making it difficult to design an ideal amount of entries within completion tracking queue 360. Allocating more entries than necessary to a VC within completion tracking queue 360 may result in a higher cost, while constraining the number of entries too strictly may severely impact performance and thereby preclude any of the advantages from providing varying QoS for the traffic classes defined for ICH 150.

In one embodiment, completion tracking queue 360 is configured to enable assignment or definition of a minimum and maximum number of entries for each VC supported by chipset 110 (FIG. 1). In one embodiment, VC allocation/removal logic enables assignment or definition of a minimum and maximum number of entries for each VC supported by chipset 110. Accordingly, once a minimum number of entries are allocated for each VC, unallocated entries are stored within a common pool of entries. In one embodiment, unallocated entries are to be shared by the various VCs supported by chipset 110 to ensure varying QoS, as defined by the traffic classes supported by chipset 110. In one embodiment, allocated logic 350 is required to limit the total number of VC0 requests such that VC0 requests never pre-empt non-VC0 requests, such as directed to VC1 or VC2 from being accepted.

In one embodiment, upstream request capture logic 320 detects upstream read requests directed to main memory 130. Representatively, request information 270 associated with the upstream NP read request is provided to available entry logic 340. In one embodiment, available entry logic 340 determines a virtual channel associated with the upstream NP read request. Once determined, available entry logic 340 determines whether an entry within completion tracking queue 360 is available for the associated virtual channel. When such is the case, request information 270 is stored within completion tracking queue. Otherwise, control logic 310 delays transmission of the upstream read request 262 until an entry for the associated virtual channel within completion tracking queue 360 becomes available.

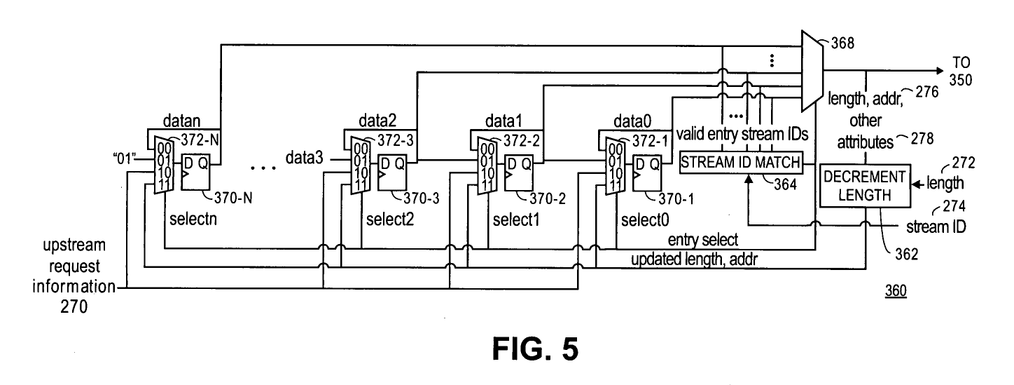

As further illustrated in FIG. 4, downstream completion capture logic 330 is responsible for determining whether a received completion 232 matches associated request information 270 within completion tracking queue 360. In one embodiment, VC allocation/removal logic 350 removes request information 270 from completion tracking queue 360 when matching request information is detected. Otherwise, the completion is identified as an unexpected completion by request information logic 310. In one embodiment, VC allocation/removal logic 350 performs entry allocation within completion tracking queue 360, as further illustrated in FIG. 5.

In one embodiment, request information 270 is loaded into the lowest available entry 370 (370-1, . . . , 370-N) within completion tracking queue 360. In one embodiment, identification of the lowest available entry within completion tracking queue 360 is determined by available entry logic 340. In one embodiment, when a completion is available at the output of downstream queue 230 (FIG. 3), stream identification 272 (e.g., requester ID and tag value) of the packet is compared against each valid stream ID within completion tracking queue 360.

In one embodiment, length information 272 is taken from the lowest queue entry 370 that matches stream ID 270 and the length of the completion packet is subtracted from length information 272. If the difference is zero, it indicates that the entire completion has returned and the entry is removed. In one embodiment, this functionality is performed by downstream completion compare logic 330 in conjunction with VC allocation/removal logic 350, as directed by request information logic 310. In one embodiment, all entries greater than the queue entry containing the matching stream ID are shifted up by one entry. In other words, in one embodiment, removal of an entry from completion tracking queue 360 results in popping off of the entry as remaining queue entries below the matching entry are shifted up.

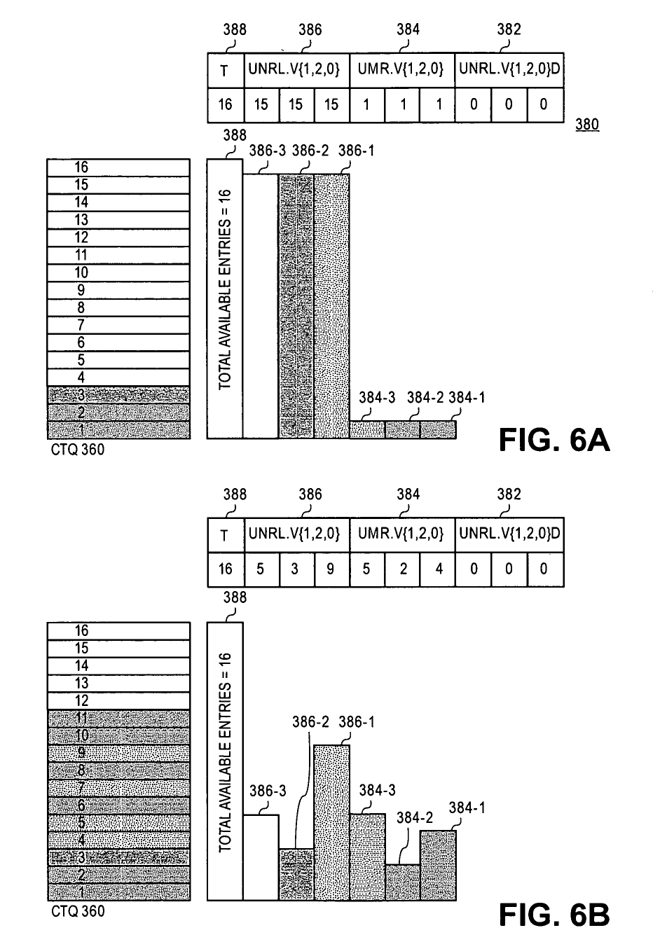

Referring again to FIG. 3, in one embodiment, upstream arbiter 254 is prohibited from granting a read request if space is unavailable within completion tracking queue 360 to store request information, for example, as determined by available entry logic 340. In one embodiment, available entry logic 340 utilizes a resource counter (not shown) for each virtual channel supported by ICH 150. In one embodiment, available entry logic 340 increments a resource counter associated with a virtual channel when a read request directed to the virtual channel is accepted and decrements the resource counter for the associated virtual channel when an entry is removed from completion tracking queue 360. In one embodiment, allocation of minimum and maximum entry values for storage of request information pertaining to a respective virtual channel is illustrated with reference to FIGS. 6A-6C.

As illustrated in FIG. 6A, the depth of completion tracking queue 360 is set at 16 entries that are to be shared by the three virtual channels supported by ICH 150. However, it will be recognized that although FIGS. 6A-6C show 16 entries to be allocated among three virtual channels supported by ICH 150, the number of entries supported by completion tracking queue 360, as well as the number of virtual channels supported by ICH 150 may be varied while remaining within the scope of the embodiments described herein. Representatively, completion tracking queue register 380 is provided to enable programming of minimum and maximum entry values for each VC supported by ICH 150.

In one embodiment, total non-posted upstream requests limit register (UNRL.T) 388 defines the total number of available entries to be provided by upstream request queue 360. As further illustrated, a non-posted upstream request limit (UNRL) register 386 is provided for each virtual channel (UNRL.V1, UNRL.Vp and UNRL.VO) to define the maximum number of entries available to the respective channel. Likewise, upstream minimum reserve (UMR) registers 384 define a minimum entry value to be allocated for each VC supported by ICH 150 (UMR.V1, UMR.Vp and UMR.V0). Finally, upstream request NP request limit disable (UNRL) registers 382 are set to disable a respective virtual channel supported by ICH 150 (UNRL.V1d, UNRL.Vpd and UNRL.V0d).

Referring again to FIG. 6A, each VC supported by ICH 150 is enabled, as indicated by UNRL.V1d, UNRL.Vpd and UNRL.V0d registers 382. Also, the minimum value for each VC is set to a value of one, as indicated by UMR.V1, UMR.Vp and UMR.V0 registers 384. Finally, the maximum entry value for each virtual channel is set to 15, as defined by UNRL.V1, UNRL.Vp and UNRL.V0 registers 386.

As further illustrated within FIG. 6B, varying minimum and maximum entry values may be defined for the VCs supported by ICH 150, as required by the desired implementation, as well as the traffic classes defined for the system architecture. As illustrated with reference to FIG. 6C, virtual channels VC1 and VC2 are disabled, whereas virtual channel VC0 is enabled, as indicated by UNRL.V0d register 382. In addition, a maximum entry value and a minimum entry value of 16 are set for VC0 to provide best effort service to each of the packet/traffic classes supported by ICH 150. Procedural methods for implementing one or more embodiments as described above are now provided.

Operation

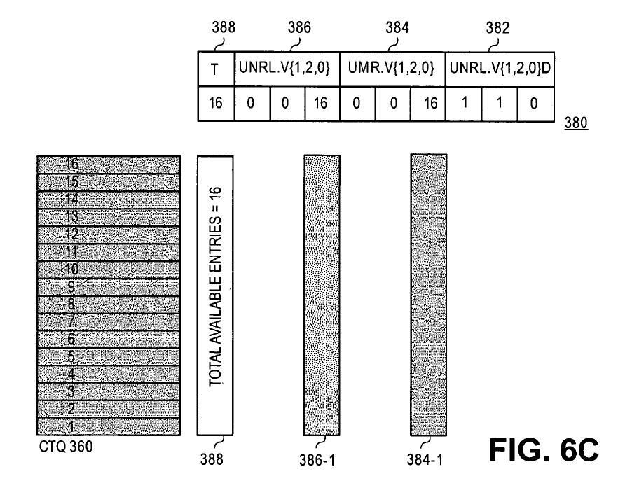

FIG. 7 is a flowchart illustrating a method 400 for limiting transmission of upstream non-posted (NP) requests to upstream requests having an available entry within a completion tracking queue, in accordance with one embodiment. At process block 420, it is detected whether an upstream NP request associated with the virtual channel is received. Once received, at process block 422, it is determined whether an entry within completion tracking queue is available for virtual channel. When such an entry is available, the upstream NP request is transmitted at process block 430. Otherwise, transmission of the upstream NP request is delayed until an entry becomes available within the completion tracking queue for the virtual channel. In one embodiment, as illustrated with reference to FIG. 4, control logic 310 prohibits upstream queues 260 from transmitting an upstream NP request until an entry is available within completion tracking queue 360.

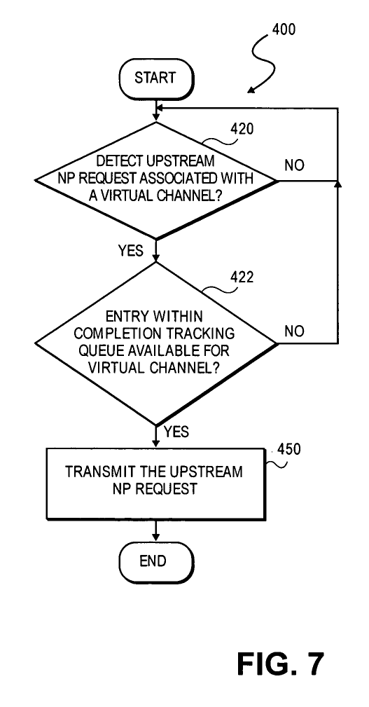

FIG. 8 is a flowchart illustrating a method 402 for allocation of entries within completion tracking queue, for example, as performed by VC allocation/removal logic 350 of FIG. 4, in one embodiment. At process block 404, a virtual channel from a plurality of virtual channels is selected. Once selected, at process block 406, entries are allocated to the selected virtual channel within the completion tracking according to a minimum entry value defined for the selected virtual channel. At process block 408, process blocks 404 and 406 are repeated until each virtual channel from the plurality of virtual channels is processed. Subsequently, at process block 410, remaining entries within the completion tracking queue are allocated to an available entry pool, which may be shared amongst the plurality of virtual channels supported by, for example, ICH 150 of FIG. 1.

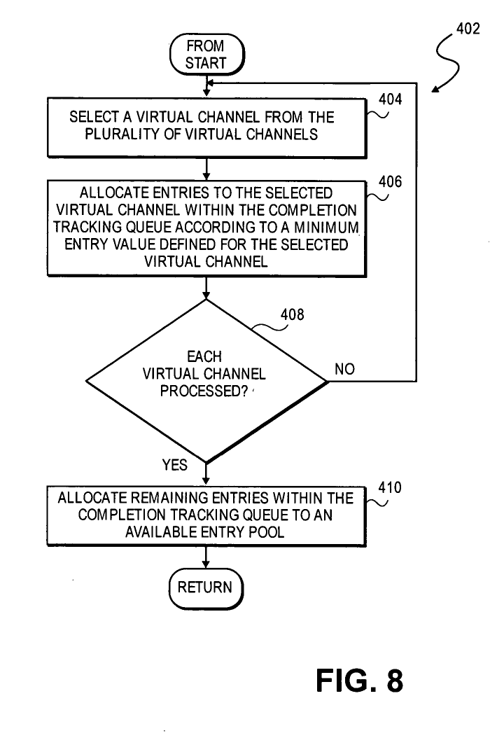

FIG. 9 is a flowchart illustrating a method 422 for determining whether an entry is available within the completion tracking queue of process block 422 of FIG. 7, in one embodiment, for example, as performed by available entry logic 340 of FIG. 4. At process block 432, a value of a resource counter for the virtual channel associated with the received upstream NP request is determined. At process block 434, it is determined whether a value of the resource counter is less than a maximum entry value defined for the virtual channel. When such is the case, at process block 435 it is determined whether there is available entry within the completion tracking queue. At process block 436, an entry for the upstream request is allocated within the completion tracking queue. At process block 448, upstream NP request information for the upstream NP request is stored within the allocated entry of the completion tracking queue.

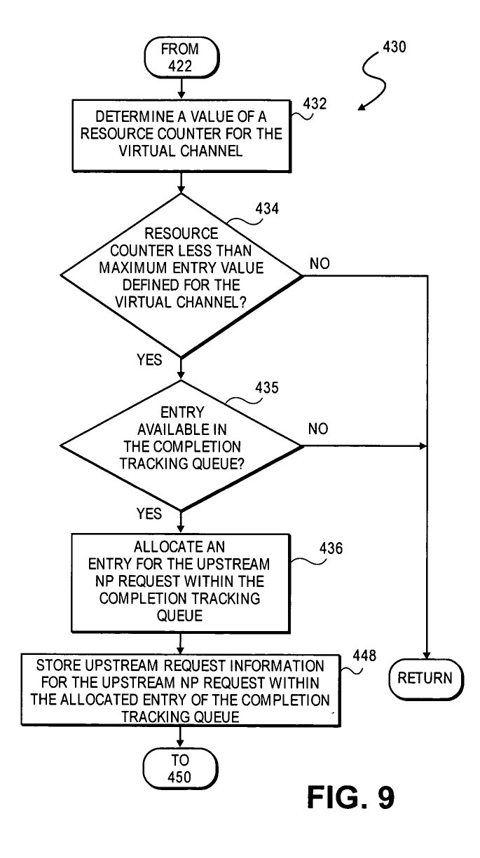

FIG. 10 is a flowchart illustrating a method 440 for allocating an entry within the completion tracking queue of process block 436 of FIG. 9, in accordance with one embodiment. At process block 442, an entry is selected from the available entry pool. Once selected, at process block 444, an entry within the completion tracking queue corresponding to the selected entry from the available entry pool is assigned to the upstream NP request. In one embodiment, method 440 is performed by VC allocation/removal logic 350 of FIG. 4.

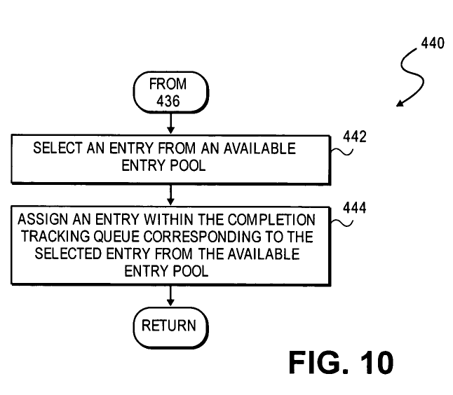

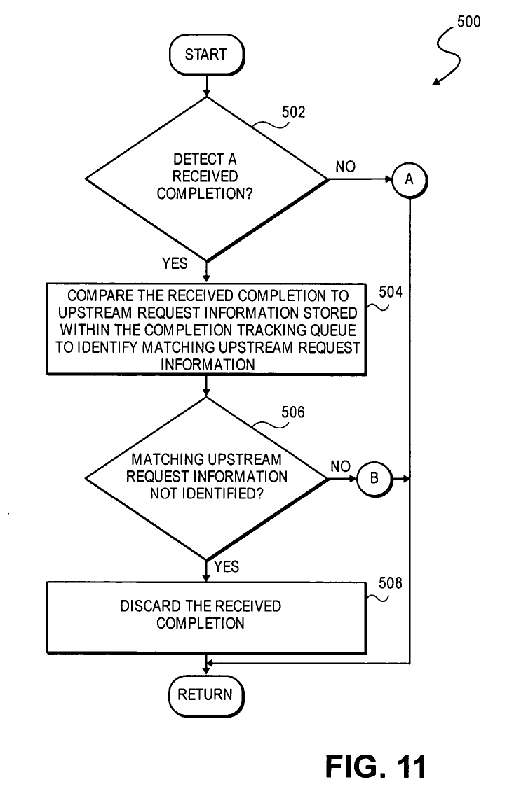

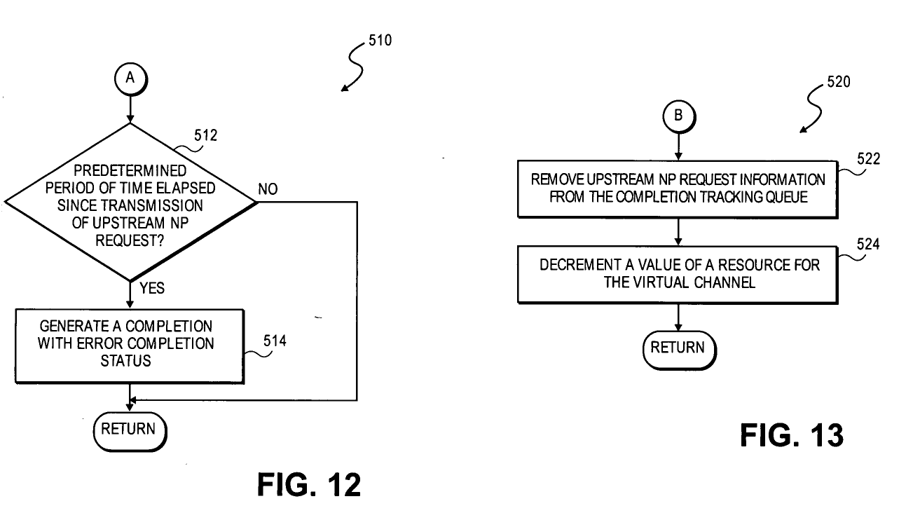

FIG. 11 is a flowchart illustrating a method 500 for discarding unmatched, received completions, in accordance with one embodiment. At process block 502, it is determined whether a received completion is detected. If a received completion is not detected, control flow branches to flowchart A, as shown in FIG. 12. Otherwise, at process block 504, the received completion is compared to upstream request information stored within the completion tracking queue to identify matching upstream request information. If matching upstream request information is not identified at process block 506, at process block 508, the received completion is discarded. Otherwise, control flow branches to flowchart B, as shown in FIG. 13.

FIG. 12 is a flowchart illustrating a method 510 to synthesize a completion, in accordance with one embodiment. At process block 512, it is determined whether a predetermined period of time has elapsed since transmission of an upstream NP request. When the predetermined amount of time has expired, at process block 516, a completion is generated or synthesized, with error completion status, for example, to prohibit legacy devices from hanging computer system 100 of FIG. 1. Otherwise, control flow returns to process block 502 of FIG. 11.

FIG. 13 is a flowchart illustrating a method 520 for removing matching upstream NP request information from the completion tracking queue, in accordance with one embodiment. At process block 522, upstream request information is removed from the completion tracking queue. At process block 524, a value of a resource counter associated with the upstream NP request is decremented, and the control flow returns to process block 502 of FIG. 11.

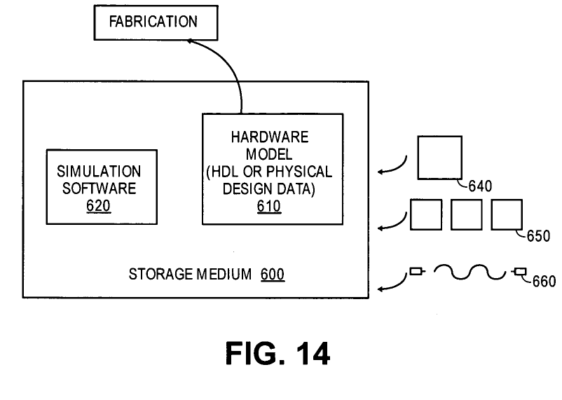

FIG. 14 is a block diagram illustrating various representations or formats for simulation, emulation and fabrication of a design using the disclosed techniques. Data representing a design may represent the design in a number of manners. First, as is useful in simulations, the hardware may be represented using a hardware description language, or another functional description language, which essentially provides a computerized model of how the designed hardware is expected to perform. The hardware model 610 may be stored in a storage medium 600, such as a computer memory, so that the model may be simulated using simulation software 620 that applies a particular test suite 630 to the hardware model to determine if it indeed functions as intended. In some embodiments, the simulation software is not recorded, captured or contained in the medium.

In any representation of the design, the data may be stored in any form of a machine readable medium. An optical or electrical wave 660 modulated or otherwise generated to transport such information, a memory 650 or a magnetic or optical storage 640, such as a disk, may be the machine readable medium. Any of these mediums may carry the design information. The term “carry” (e.g., a machine readable medium carrying information) thus covers information stored on a storage device or information encoded or modulated into or onto a carrier wave. The set of bits describing the design or a particular of the design are (when embodied in a machine readable medium, such as a carrier or storage medium) an article that may be sealed in and out of itself, or used by others for further design or fabrication.

### Alternate Embodiments

It will be appreciated that, for other embodiments, a different system configuration may be used. For example, while the system 100 includes a single CPU 102, for other embodiments, a multiprocessor system (where one or more processors may be similar in configuration and operation to the CPU 102 described above) may benefit from the programmable completion tracking queue to support multiple virtual channels of various embodiments. Further different type of system or different type of computer system such as, for example, a server, a workstation, a desktop computer system, a gaming system, an embedded computer system, a blade server, a system on-chip, etc., may be used for other embodiments.

Having disclosed exemplary embodiments and the best mode, modifications and variations may be made to the disclosed embodiments while remaining within the scope of the embodiments of the invention as defined by the following claims.

1. A controller comprising:
a programmable completion tracking queue to provide a number of entries to store upstream request information corresponding to at least one upstream request associated with one of a plurality of virtual channels, the number of entries to be shared among the virtual channels according to a minimum entry value and a maximum entry value defined for each respective virtual channel; and
control logic to prohibit transmission of an upstream request associated with a virtual channel unless an entry within the completion tracking queue is available for the virtual channel.

2. The controller of claim 1, wherein the control logic is to allocate an entry for an upstream non-posted read request corresponding to a virtual channel if a value of a resource counter for the virtual channel is less than a minimum entry value defined for the virtual channel.

3. The controller of claim 1, wherein the control logic is to compare a received completion to upstream request information stored within the completion tracking queue to identify matching upstream request information and to discard the received completion if the matching upstream request information is not identified within the completion tracking queue.

4. The controller of claim 1, wherein the control logic is to generate a completion with error completion status when a completion for an upstream request is not received within a defined period of time following transmission of the upstream request.

5. The controller of claim 1, further comprising:
an upstream request queue coupled to the completion tracking queue, the upstream request queue to store upstream read requests until transmission of the upstream read requests to memory.

6. The controller of claim 5, further comprising:
a downstream completion queue coupled to the completion tracking queue, the downstream completion queue to store completion information for completions received from memory.

7. The controller of claim 1, wherein the controller further comprises a system on-chip.

8. The controller of claim 1, wherein the controller further comprises:
a chipset including an integrated memory controller hub and an integrated input/output (I/O) controller hub.

9. The controller of claim 8, wherein the control logic is to allocate an entry for an upstream non-posted read request corresponding to a virtual channel if a value of a resource counter for the virtual channel is less than a maximum entry value defined for the virtual channel and an entry within a common pool of entries is available.

10. The controller of claim 1, wherein the plurality of virtual channels include a best effort class virtual channel (VC0), an isochronous traffic virtual channel (VC1) and a snoop isochronous traffic virtual channel (VC2).

11. A system comprising:
a processor;
a memory; and
a chipset coupled between the processor and the memory, the chipset comprising:
an input/output (I/O) controller hub comprising:
a programmable completion tracking queue to provide a number of entries to store upstream read request information corresponding to at least one upstream non-posted read request associated with one of a plurality of virtual channels, the number of entries to be shared among the virtual channels according to a minimum entry value and a maximum entry value defined for each respective virtual channel, and
control logic to prohibit transmission of an upstream read request associated with a virtual channel unless an entry within the completion tracking queue is available for the virtual channel.

12. The system of claim 11, wherein the I/O controller hub further comprises:
an upstream request queue coupled to the completion tracking queue, the upstream request queue to store upstream read requests until transmission of the upstream read requests to the memory.

13. The system of claim 11, wherein the controller further comprises:
a downstream completion queue coupled to the completion tracking queue, the downstream completion queue to store completion information for completions received from memory.

14. The system of claim 11,
wherein the control logic is to allocate an entry for an upstream non-posted read request corresponding to a virtual channel if a value of a resource counter for the virtual channel is less than a maximum entry value defined for the virtual channel;
wherein the control logic is to compare a received completion to upstream request information stored within the completion tracking queue to identify matching upstream request information and to discard the received completion if the matching upstream request information is not identified within the completion tracking queue; and
wherein the control logic is to generate a completion with error completion status when a completion for an upstream request is not received within a defined period of time following transmission of the upstream request.

15. The system of claim 11, wherein the processor further comprises an integrated memory controller.

16. The system of claim 11, wherein the I/O controller hub comprises at least one root port.

17. The system of claim 11, wherein the chipset further comprises:
a memory controller hub coupled between memory and the controller.

18. The system of claim 11, wherein the chipset further comprises an integrated memory controller.

19. The system of claim 11, wherein the plurality of virtual channels include a best effort class virtual channel (VC0), an isochronous traffic virtual channel (VC1) and a snoop isochronous traffic virtual channel (VC2).

20. The system of claim 16, further comprises:
a switch coupled to the at least one root port; and
at least one peripheral device coupled to the switch, the peripheral device to issue the upstream non-posted read request to the memory.

21. A method comprising:
detecting an upstream request associated with a virtual channel from a plurality of virtual channels;
determining whether an entry within a completion tracking queue is available for the virtual channel; and
transmitting the upstream request if an entry within the completion tracking queue is available for the virtual channel.

22. The method of claim 21, wherein transmitting the upstream request further comprises:
determining a value of a resource counter for the virtual channel;
allocating an entry for the upstream request within the completion tracking queue if the value of the resource counter is less than a maximum entry value defined for the virtual channel; and
storing upstream request information for the upstream request within the allocated entry of the completion tracking queue.

23. The method of claim 21, further comprising:
detecting a received completion;
comparing the received completion to upstream request information stored within the completion tracking queue to identify matching upstream request information; and
discarding the received completion if matching upstream request information is not identified within the completion tracking queue.

24. The method of claim 21, further comprising:
determining whether a predetermined period of time has elapsed since transmission of an upstream request; and
generating a completion with error completion status if the predetermined period of time has expired since the transmission of the upstream request.

25. The method of claim 21, wherein the upstream request is an upstream non-posted read request directed to main memory.

26. The method of claim 21, wherein the plurality of virtual channels include a best effort class virtual channel (VC0), an isochronous traffic virtual channel (VC1) and a snoop isochronous traffic virtual channel (VC2).

27. The method of claim 21, wherein prior to detecting, the method comprises:
selecting a virtual channel from the plurality of virtual channels;
allocating entries to the selected virtual channel within the completion tracking queue according to a minimum entry value defined for the selected virtual channel;
repeating the selecting of the virtual channel and the allocating of entries for each virtual channel of the plurality of virtual channels; and
allocating remaining entries within the completion tracking queue to an available entry pool.

28. The method of claim 22, wherein allocating the entry comprises:
selecting an entry from an available entry pool if the value of the resource counter for the virtual channel is less than a maximum entry value defined for the virtual channel; and
assigning an entry within the completion tracking queue corresponding to the selected entry from the available entry pool.

29. The method of claim 23, further comprising:
removing upstream request information from the completion tracking queue if matching upstream request information is identified within the completion tracking queue.

30. The method of claim 29, wherein removing further comprises:
decrementing a value of a resource counter for the virtual channel; and
reallocating the identified entry within the completion tracking queue to an available entry pool if a value of the resource counter for the virtual channel is greater than or equal to the maximum entry value defined for the virtual channel.
